(19) United States
(12) Patent Application Publication
(10) Pub. No.: US 2020/0279155 A1
(43) Pub. Date: Sep. 3, 2020

(54) EFFICIENT AND SECURE GRADIENT-FREE BLACK BOX OPTIMIZATION

(71) Applicant: International Business Machines Corporation, Armonk, NY (US)

(72) Inventors: Sijia Liu, CAMBRIDGE, MA (US); Pin-Yu Chen, YORKTOWN HEIGHTS, NY (US); Chuang Gan, YORKTOWN HEIGHTS, NY (US); Lisa Amini, YORKTOWN HEIGHTS, NY (US)

(21) Appl. No.: 16/288,975

(22) Filed: Feb. 28, 2019

(51) Int. Cl. G06N 3/08; G06N 5/02; G06N 20/00

(52) U.S. Cl. CPC G06N 3/08; G06N 20/00; G06N 5/02

(57) ABSTRACT

A black box optimization method, system, and computer program product include implementing an average gradient estimator using a forward difference of function values at multiple random directions, performing variance reduction via gradient blending with an output of the average gradient estimator using a control variate, and performing binary quantization of a result of the variance reduction.

### BACKGROUND

The present invention relates generally to a black box optimization method, and more particularly, but not by way of limitation, to a system, method, and computer program product for black box optimization by improving the convergence rate of Zeroth-order (ZO)-methods towards first-order cases and minimizing the information used in ZO gradient estimation.

Zeroth-order (gradient-free) optimization has attracted an increasing amount of attention for solving machine-learning (ML) problems in scenarios where explicit expressions for gradients are difficult or infeasible to obtain.

One conventional technique generates prediction-evasive adversarial examples (e.g., crafted images with imperceptible perturbations to deceive a well-trained image classifier into misclassification). However, the black-box (i.e., where the internal structure/design implantation of the item being tested is not known to the tester) optimization nature limits the practical design of adversarial examples, where internal configurations and operating mechanisms of public ML systems are not revealed to practitioners and the only mode of interaction with the system is via submitting inputs and receiving the corresponding predicted outputs.

### SUMMARY

Thus, the inventors observed in both white-box (i.e., where the internal structure/design implementation of the item being tested is known to the tester) and black-box settings that simply leverage the sign information of gradient estimates of an attacking loss can achieve superior empirical performance in generating adversarial examples. Spurred by that, the inventors propose a zeroth-order (ZO) sign-based descent algorithm (e.g., ‘ZO-signSGD’) for solving black-box optimization problems (e.g., design of black-box adversarial examples).

In an exemplary embodiment, the present invention provides a computer-implemented black box optimization method, the method including implementing an average gradient estimator using a forward difference of function values at multiple random directions, performing variance reduction via gradient blending with an output of the average gradient estimator using a control variate, and performing binary quantization of a result of the variance reduction.

One or more other exemplary embodiments include a computer program product and a system, based on the method described above.

Other details and embodiments of the invention will be described below, so that the present contribution to the art can be better appreciated. Nonetheless, the invention is not limited in its application to such details, phraseology, terminology, illustrations and/or arrangements set forth in the description or shown in the drawings. Rather, the invention is capable of embodiments in addition to those described and of being practiced and carried out in various ways and should not be regarded as limiting.

As such, those skilled in the art will appreciate that the conception upon which this disclosure is based may readily be utilized as a basis for the designing of other structures, methods and systems for carrying out the several purposes of the present invention. It is important, therefore, that the claims be regarded as including such equivalent constructions insofar as they do not depart from the spirit and scope of the present invention.

### BRIEF DESCRIPTION OF THE DRAWINGS

Aspects of the invention will be better understood from the following detailed description of the exemplary embodiments of the invention with reference to the drawings, in which:

FIG. 1 exemplarily shows a high-level flow chart for a black box optimization method 100 according to an embodiment of the present invention;

FIG. 2 exemplarily depicts a flow of the invention according to an embodiment of the present invention;

FIG. 3 exemplarily depicts a first algorithm according to an embodiment of the present invention;

FIGS. 4(a)-6 exemplarily depict results according to an embodiment of the present invention;

FIG. 7 depicts a cloud-computing node 10 according to an embodiment of the present invention;

FIG. 8 depicts a cloud-computing environment 50 according to an embodiment of the present invention; and

FIG. 9 depicts abstraction model layers according to an embodiment of the present invention.

### DETAILED DESCRIPTION

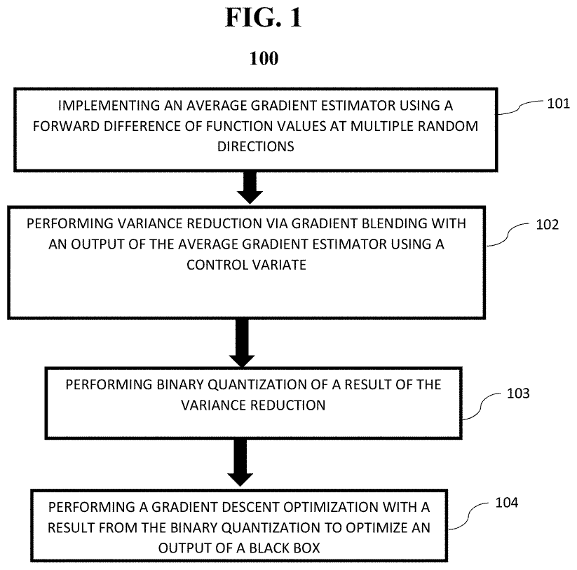

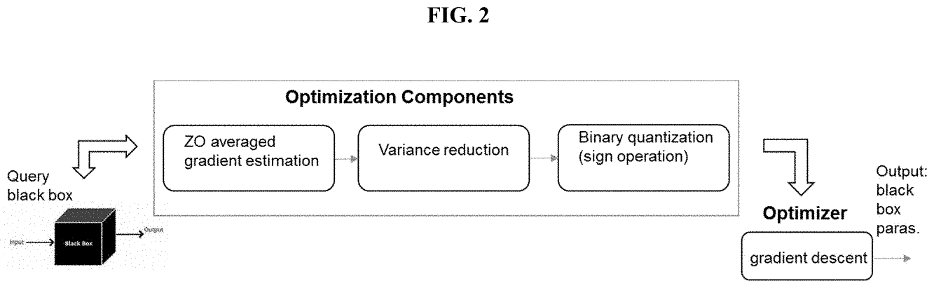

The invention will now be described with reference to FIGS. 1-9, in which like reference numerals refer to like parts throughout. It is emphasized that, according to common practice, the various features of the drawings are not necessarily to scale. On the contrary, the dimensions of the various features can be arbitrarily expanded or reduced for clarity.

By way of introduction of the example depicted in FIG. 1, an embodiment of a black box optimization method 100 according to the present invention can include various steps for efficient and secure gradient-free optimization.

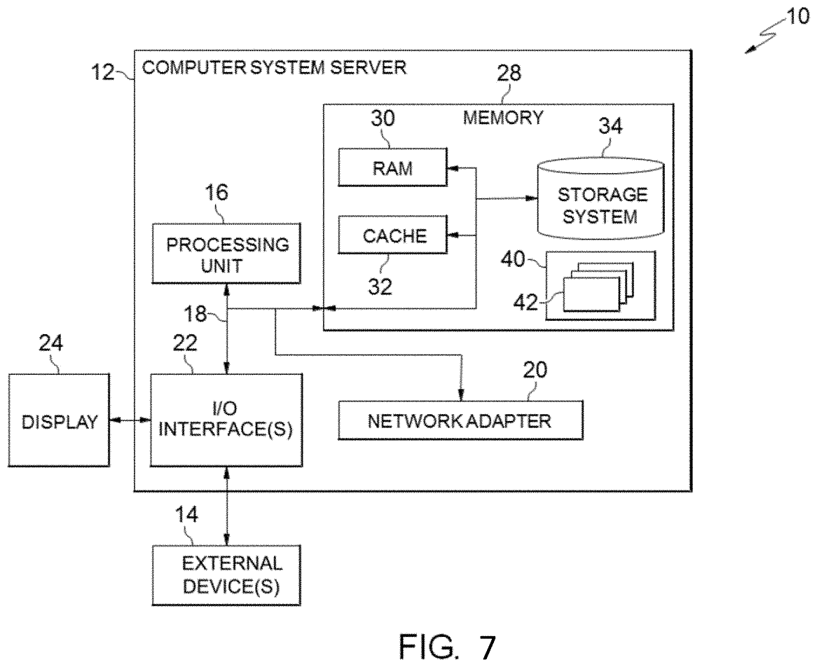

By way of introduction of the example depicted in FIG. 7, one or more computers of a computer system 12 according to an embodiment of the present invention can include a memory 28 having instructions stored in a storage system to perform the steps of FIG. 1.

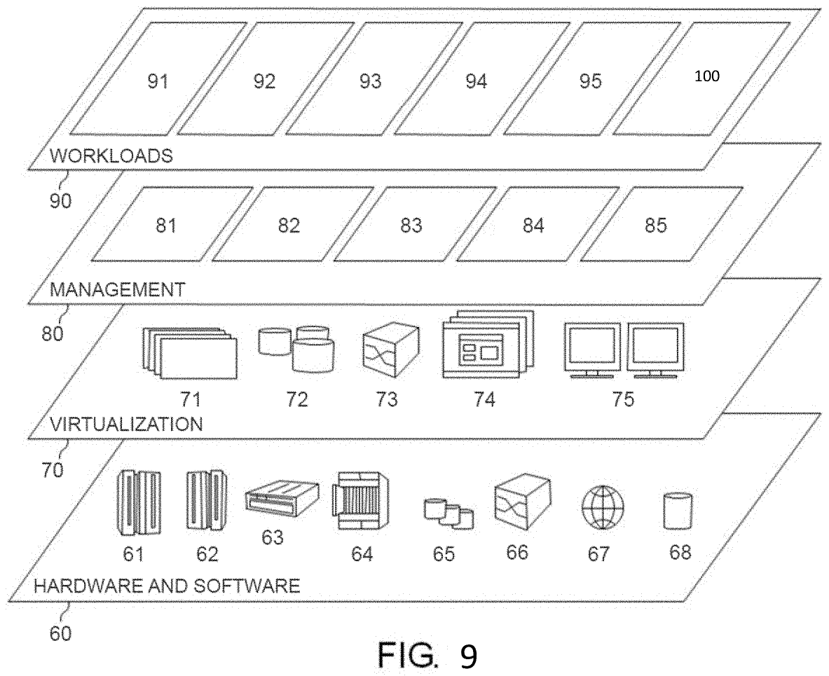

Although one or more embodiments may be implemented in a cloud environment 50 (e.g., FIG. 9), it is nonetheless understood that the present invention can be implemented outside of the cloud environment.

With reference to FIG. 1, the method 100 provides for efficient (e.g., fast convergence speed, less query/iteration complexity (query is not free)) and secure (e.g., sign information and low communication cost) gradient-free optimization.

In step 101, an average gradient estimator is implemented using a forward difference of function values at multiple random directions. That is, the gradient estimator includes the following equation which is discussed in more detail later:

$$\hat{G} ( x ) = \frac{1}{q} {\sum }_{i = 1}^{q} \frac{f ( x + β {z}_{i} ) - f ( x )}{β} {z}_{i} , {z}_{i} \sim N ( 0 , I )$$

In step 102, variance reduction via gradient blending is performed with an output (e.g., Ĝ(x))) of the average gradient estimator using a control variate. The following equation is used for the variance reduction which is discussed in more detail later:

\tilde{G}(x)=ĝ(x)−ĝ(x₀)+Ĝ(x₀), where x₀ is an anchor point

In step 103, binary quantization of a result of the variance reduction is performed. In other words, G(x)=sign(\tilde{G}(x)) as described later.

And, in step 104, a gradient descent optimization is performed with a result from the binary quantization to optimize an output of a black box (e.g., x_{new}=x_{old}−ηG(x_{old})) as described later.

The method 100 includes a new zeroth-order (ZO) algorithm, ‘ZO-signSGD’, and rigorously prove its convergence rate of O(\sqrt{d}/\sqrt{T}) under mild conditions, where d is the number of optimization variables. The result matches the best-known rate of ZO algorithms without using any additional variance reduced technique. The inventive analysis removes the impractical assumption of b=O(T) used in a conventional technique, and allows mini-batch samples both with and without replacement. The invention further develops and analyzes two variants of ZO-signSGD, which are built on different types of gradient estimators using central difference of function values and using signs of estimates with a majority vote. It is shown that these variants lead to at least the same convergence rate of ZO-signSGD.

As a preliminary matter, a background on signSGD, together with a problem setup is provided for explaining the invention. In particular, it is shown that the commonly-used methods for generating adversarial attacks fall into the framework of signSGD. For preliminaries on signSGD, a nonconvex finite-sum problem of the form of problem (1) is considered.

$${minimize}_{x} f ( x ) := ( 1 / n ) {\sum }_{i = 1}^{n} {f}_{1} ( x ) , \qquad ( 1 )$$

In problem (1), xϵ [symbol] ^{d} are optimization variables, and {ƒᵢ} are n individual nonconvex cost functions. The finite-sum form of problem (1) encompasses many machine learning (ML) problems, ranging from generalized linear models to neural networks. If the gradients of {ƒᵢ} are available, then problem (1) can be solved by many first-order methods such as stochastic gradient descent (SGD), stochastic coordinate descent (SCD), and signSGD. The technique of interest is signSGD, which differs from SGD and SCD, in that it takes the sign of gradient (or its estimate) as the descent direction.

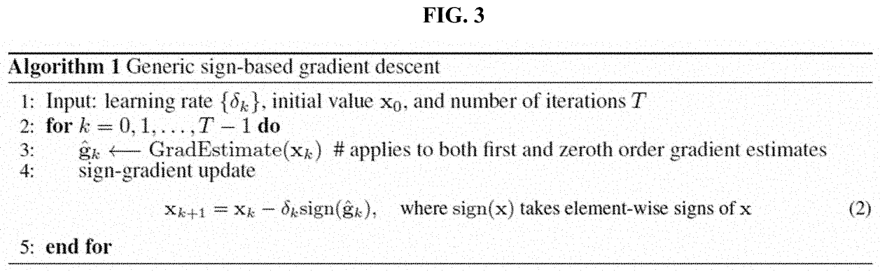

The algorithm shown in FIG. 3 provides a sign-based gradient descent framework that encapsulates different variants of signSGD. In the algorithm, GradEstimate (·) signifies a general gradient estimation procedure, which adopts either a stochastic gradient estimate in the first-order setting of signSGD or a function difference based random gradient estimate in its ZO setting. The ZO variant of signSGD will be elaborated later.

In regards to adversarial attacks meeting signSGD, it is now widely known that ML models (e.g., deep neural networks) are vulnerable to adversarial attacks, which craft inputs (e.g., images) with imperceptible perturbations to cause incorrect classification. The resulting inputs crafted by adversaries are known as ‘adversarial examples’. Investigating adversarial examples not only helps to understand the limitation of learning models, but also provides opportunities to improve the models' robustness. Below, it is shown that the generation of adversarial examples can be interpreted through signSGD.

Let x₀ denote the natural (legitimate) input of an ML model associated with the true label to, and x′=x₀+δ be the adversarial example to be designed, where δ are adversarial perturbations. If f(x, t₀) is the training loss of a learning model, then the goal of a (white-box) adversarial attack is to find a minimal perturbation δ that is sufficient to mislead the learning model, namely, to maximize the loss f(x₀+δ, t₀). Taking the first-order approximation of ƒ(x′, t₀) around x₀, one obtains ƒ(x′, t₀)≈ƒ(x₀, t₀)+<∇ₓƒ(x₀, t₀), δ>. By constraining the strength of perturbation in the l_{∞} ball of small radius ε (i.e., ∥δ∥_{∞}≤ε), the linear approximation of ƒ(x′, t₀) is then maximized at δ=ε sign(∇ₓƒ(x₀, t₀)). Therefore, generation of adversarial examples obeys the sign-gradient update rule in (2) of the algorithm in FIG. 3.

Now, with reference to the inventive ZO-signSGD technique for black box optimization, one limitation of signSGD is the need of first-order information (i.e., stochastic gradients). However, as highlighted above, there exists a large practical demand for solving ML problems where explicit expressions of the gradients are difficult or infeasible to obtain. This motivates the inventive ZO-signSGD method.

In the ZO setting where the first-order information is unavailable, the gradient estimator at Step 3 of Algorithm 1 in FIG. 3 has only access to function values of {ƒᵢ(x)} given a query point x. Based on that, a ZO gradient estimate is constructed through a forward difference of two function values. In Algorithm 1, GradEstimate (x) is then specified as equation (3):

$$GradEstimate ( x ) = \frac{1}{bq} \text{?} {\sum }_{𝒥 = 1}^{q} \hat{∇} {f}_{i} ( x ; {u}_{i , 𝒥} ) , \\ \hat{∇} {f}_{i} ( x ; {u}_{i , 𝒥} ) := \frac{d [ {f}_{i} ( x + μ {u}_{i , 𝒥} ) - {f}_{i} ( x ) ]}{μ} \text{?} \\ \text{?} \text{indicates text missing or illegible when filed} \qquad ( 3 )$$

where x=xₖ in Algorithm 1, [symbol] is a mini-batch of size | [symbol] |=bᵢ{u_{i,j}}ⱼ₌₁^{q} are independent and identically distributed (i.i.d.) random directions drawn from a uniform distribution over a unit sphere, and \hat{∇}ƒᵢ(xᵢu_{i,j}) gives a conventional two-point based random gradient estimate with direction u_{i,j} and smoothing parameter μ>0.

It is highlighted that unlike the first-order stochastic gradient estimate, the ZO gradient estimate of (3) is a biased approximation to the true gradient of ƒ. Instead, it becomes unbiased to the gradient of the randomized smoothing function ƒ_{μ} of equation (4):

$${f}_{μ} ( x ) = {𝔼}_{v} [ f ( x + μ v ) ] = \frac{1}{n} {\sum }_{i = 1}^{n} {𝔼}_{v} [ {f}_{i} ( x + μ v ) ] = \frac{1}{n} {\sum }_{i = 1}^{n} {f}_{i , μ} ( x ) , \qquad ( 4 )$$

where ƒ_{i,μ} gives the randomized smoothing version of ƒᵢ, and the random variable v follows a uniform distribution over the unit Euclidean ball. Clearly, there exists a gap between a ZO gradient estimate and the true gradient of ƒ, but as will be evident later, such a gap can be measured through the smoothing function ƒ_{μ}.

Algorithm 1 becomes ZO-signSGD as the ZO gradient estimate (3) is applied. It is noted that the extension from first order to ZO is highly nontrivial, as the inventive ZO-signSGD algorithm yields three distinct differences to signSGD.

First, ZO-signSGD has no restriction on the mini-batch size b. Recall that signSGD achieves O(1/√T) convergence rate given the condition that the mini-batch size is sufficiently large, b=O(T). However, this condition only becomes true when the mini-batch sample is randomly selected from [n] with replacement, which is unusual when n≤T. Here [n] represents the integer set {1, 2, . . . , n}. And, signSGD fails to cover signGD when b=n, since sampling with replacement leads to [symbol] ₖ≠└n┘ even if b=n. In the inventive ZO-signSGD algorithm, the assumption is relaxed on b and mini-batch sampling both with and without replacement is considered.

Moreover, ZO-signSGD requires a more involved analysis to reveal the statistical properties of the ZO gradient estimator in (3) since it covers two kinds of randomness from mini-batch sampling as well as from random direction sampling. By contrast, signSGD only requires to bound the variance of (first-order) stochastic gradients under the assumption of independent and identically distributed (i.i.d.) mini-batch samples (with replacement).

Third, ZO-signSGD requires an evaluation of the error propagation from the sign of a ZO gradient estimate to the true gradient. However, both the sign operation and the random gradient estimation induce biased approximations to the true gradient. Thus, current analysis cannot handle this complex ZO scenario, and a new analysis beyond signSGD is required.

To analyze the convergence of the ZO-signSGD technique, assumptions used in the analysis are stated. Assumptions of problem (1) are listed as follows:

A1: Functions {ƒᵢ} have L-Lipschitz continuous gradients, where Lϵ(0, ∞).

A2: The gradient of ƒᵢ is upper bounded by ∥∇ƒᵢ(x)∥₂≤σ for iϵ[i].

A1 implies the L-smoothness of ƒᵢ, namely, for any x and y, one obtains

ƒᵢ(x)−ƒᵢ(y)≤ [symbol] ∇ƒᵢ(y),x−y [symbol] +(L/2)∥x−y∥ᵢ².

A2 implies the bounded variance of ∇ƒᵢ, namely,

$$\frac{1}{n} {\sum }_{i = 1}^{n} {‖ ∇ {f}_{i} ( x ) - ∇ f ( x ) ‖}_{2}^{2} \leq 4 {σ}^{2} ,$$

where one has used the fact that ∥∇ƒ(x)∥₂≤σ under A2. And, it is noted that it is assumed that problem (1) is solvable, namely, f(x*)>−∞ where x* is an optimal solution.

It is noted that Algorithm 1 becomes ZO-signSGD when the gradient estimation step (3) is applied. For nonconvex problems, the convergence of an algorithm is typically measured by stationarity, e.g., using ∥∇f(x)∥₂ in SGD and ∥∇f(x)∥₁ in signSGD. For the latter, the l₁ geometry is met while quantifying the stochasticity through the (non-linear) sign operation. Different from signSGD, ZO-signSGD only obtains a biased estimate to the true gradient. In Proposition 1 below, such a bias is bypassed by leveraging the randomized smoothing technique used for ZO optimization.

$$\begin{matrix} Proposition 1 & \\ Under AI , the outputs {\{ {x}_{k} \}}_{k = 0}^{T - 1} of ZO \text{-} signSGD , \\ i . e . , Algorithm 1 with ( 3 ) , \\ satisfies {\sum }_{k = 0}^{T - 1} ( {δ}_{k} 𝔼 [ {‖ ∇ {f}_{μ} ( {x}_{k} ) ‖}_{1} ] ) \leq 𝔼 [ {f}_{μ} ( {x}_{0} ) - {f}_{μ} ( {x}_{T} ) ] + {\sum }_{k = 0}^{T - 1} [ 2 {δ}_{k} \sqrt{d} \sqrt{𝔼 [ {‖ {\hat{g}}_{k} - ∇ {f}_{μ} ( {x}_{k} ) ‖}_{2}^{2} ]} ] + \frac{d L}{2} {\sum }_{k = 0}^{T - 1} {δ}_{k}^{2} , \\ where the expectation is taken with respect to all the randomness of ZO \text{-} signSGD , {f}_{μ} is the randomized smoothing function of f in ( 4 ) , and {\hat{g}}_{k} = GradEstimate ( {x}_{k} ) in ( 3 ) . & ( 5 )\end{matrix}$$

In Proposition 1, the rationale behind introducing the smoothing function ƒ_{μ} is that ∇ ƒ_{μ} (xₖ) is the mean of ZO gradient estimate g\hat{ }k. And thus, the convergence of ZO-signSGD is now linked with the variance of ĝₖ, i.e., [symbol] [∥ĝₖ−∇ƒ_{μ}(xₖ)∥₂²]. This crucial relationship presented in Proposition 1 holds for a general class of signSGD-type algorithms that use different ZO gradient estimators. Spurred by (5), next it is investigated the second-order moment of g\hat{ }k in Proposition 2.

$$\begin{matrix} Proposition 2 & \\ Under A 1 and A 2 , the variance of ZO gradient estimate {\hat{g}}_{k} is upper bounded by 𝔼 [ {‖ {\hat{g}}_{k} - ∇ {f}_{μ} ( {x}_{k} ) ‖}_{2}^{2} ] \leq \frac{4 {α}_{b} ( q + 1 )}{bq} {σ}^{2} + \frac{( 2 {α}_{δ} + {β}_{b} )}{bq} C ( d , μ ) , & ( 6 ) \\ where C ( d , μ ) := 2 d {σ}^{2} + {μ}^{2} {L}^{2} {d}^{2} / 2. \\ In ( 6 ) , {α}_{b} and {β}_{b} are Boolean variables depending on the choice of mini \text{-} batch sampling , \\ \{ \begin{matrix}{α}_{b} = 1 , {β}_{b} = 0 & for mini \text{-} batch with replacement \\ {α}_{b} = I ( b < n ) , {β}_{b} = I ( b > 1 ) & for mini \text{-} batch without replacement ,\end{matrix} \\ where I ( x > a ) is the indicator function of x with respect to the constraint x > a , and I ( x > a ) = 1 if x > a and 0 otherwise . & ( 7 )\end{matrix}$$

Compared to the variance bound (σ²/b) of the stochastic gradient estimate of ƒ in signSGD, Proposition 2 provides a new and more general result for the ZO gradient estimate g\hat{ }k. It is clear that the bound in (6) contains two parts:

$${h}_{1} := \frac{4 {α}_{b} ( q + 1 )}{bq} {σ}^{2} and {h}_{2} := \frac{( 2 {α}_{b} + {β}_{b} )}{bq} C ( d , μ ) .$$

where the former h₁=O(σ²/b) characterizes the reduced variance (using b mini-batch samples) for the stochastic gradient estimate of the smoothing function ƒ_{μ}, and the latter h₂=O(C(d, μ)/(bq)) reveals the dimension-dependent variance induced by ZO gradient estimation using b mini-batch samples and q random directions. If a stochastic gradient estimate of ƒ is used in signSGD, then h₂ is eliminated and the variance bound in (6) is reduced to (σ²/b).

Furthermore, Proposition 2 covers mini-batch sampling with and without replacement, while signSGD only considers the first case. For the second case, Proposition 2, implies that if b=n (i.e., [symbol] =┌n┐ for a batch ZO-signSGD), then the variance [symbol] [∥ĝₖ−∇ƒ_{μ}(xₖ)∥₂²] is reduced to O(C(d, μ)/(nq)), corresponding to α_{b}=0 and β_{b}=1 in (7). In the other extreme case of b=1, both the studied mini-batch schemes become identical, leading to α_{b}=1 and β_{b}=0. Proposition 2 also implies that the use of large b and q reduces the variance of the gradient estimate, and will further improve the convergence rate.

With the aid of Proposition 1 and 2, it can then be shown the convergence rate of ZO-signSGD in terms of stationarity of the original function ƒ. The remaining difficulty is how to bound the gap between f and its smoothed version ƒ_{μ}. It has been shown that there exists a tight relationship between ƒ_{μ} and ƒ given the fact that the former is a convolution of the latter and the density function of a random perturbation v in (4). The convergence rate of ZO-signSGD is demonstrated in Theorem 1.

$$\begin{matrix} Theorem 1 Under A 1 and A 2 , if we randomly pick {x}_{R} & ( 8 ) \\ from {\{ {x}_{k} \}}_{k = 0}^{T - 1} with probability P ( R = k ) = \frac{{δ}_{k}}{{\sum }_{k = 0}^{T - 1} {δ}_{k}} , then & \\ the convergence rate of ZO \text{-} signSGD is given by & \\ 𝔼 [ {‖ ∇ f ( {x}_{R} ) ‖}_{2} ] \leq \frac{\sqrt{2} ( f ( {x}_{0} ) - {f}^{*} + {μ}^{2} L )}{{\sum }_{k = 0}^{T - 1} {δ}_{k}} + \frac{dL}{\sqrt{2}} \frac{{\sum }_{k = 0}^{T - 1} {δ}_{k}^{2}}{{\sum }_{k = 0}^{T - 1} {δ}_{k}} + \frac{μ Ld}{\sqrt{2}} + \frac{2 \sqrt{2} \sqrt{d} \sqrt{4 {α}_{b} ( q + 1 ) {σ}^{2} + C ( d , μ ) ( 2 {α}_{b} + {β}_{b} )}}{\sqrt{bq}} , & \end{matrix}$$

where ƒ* denotes the minimum value.

In Theorem 1, the norm of the gradient is translated from l₁ to l₂ based on ∥x∥₂≤∥x∥₁ for any x. Note that a probabilistic output x_{R} is adopted in Theorem 1, in order to avoid an exhaustive search over {xₖ} for minₖ∥∇f(xₖ)∥₂. The convergence rate of ZO-signSGD relies on the learning rate δₖ, the problem size d, the smoothing parameter μ, the mini-batch size b, and the number of random perturbations q for ZO gradient estimation. In order to acquire explicit dependence on these parameters, several special cases covered in Theorem 1 are discussed below.

If

$${δ}_{k} = δ = O ( \frac{1}{\sqrt{dT}} ) and μ = O ( \frac{1}{\sqrt{dT}} ) ,$$

then the convergence given by (8) simplifies to

$$O ( \frac{√ d}{\sqrt{T}} + \frac{\sqrt{d} \sqrt{{α}_{b} q + ( {α}_{b} + {β}_{b} ) d}}{\sqrt{bq}} ) ,$$

where one has used the fact that, in this case, we have

$$C ( d , μ ) = 2 d {σ}^{2} + \frac{{dL}^{2}}{2 T} .$$

According to (7), ZO-signSGD using mini-batch samples with replacement yields

$$O ( \frac{\sqrt{d}}{\sqrt{T}} + \frac{\sqrt{d}}{\sqrt{b}} + \frac{d}{\sqrt{bq}} )$$

convergence rate, while the rate under mini-batch without replacement remains the same at bϵ[1, n), but it is improved to

$$O ( \frac{\sqrt{d}}{\sqrt{T}} + \frac{d}{\sqrt{nq}} )$$

at b=n (corresponding to the batch version of ZO-signSGD).

In the latter case, if

$$q = O ( \frac{dT}{n} ) ,$$

is chosen,

$$O ( \frac{\sqrt{d}}{\sqrt{T }} )$$

is obtained as the convergence rate, whose optimality was proved under the framework of ZO mirror descent. Here the choice of making the number of random direction samples q proportional to T yields the variance of the ZO gradient estimate inversely proportional to T (e.g., see Proposition 2), commonly used in ZO optimization for variance reduction. Furthermore, similar to signSGD, if it is assumed b=O(T) and q=O(d), one can also obtain

$$O ( \frac{\sqrt{d}}{\sqrt{T }} )$$

convergence rate in the case of mini-batch with replacement. Instead of using a constant learning rate, if one chooses the decaying rate of

$${δ}_{k} = \frac{1}{\sqrt{dk}} ( with {δ}_{0} = {δ}_{1} = \frac{1}{\sqrt{d}} ) ,$$

it is not difficult to show that the aforementioned rates also hold.

Next, two variants of ZO-signSGD are shown, where the gradient will be estimated using the central difference of function values or the signs of ZO gradient estimates with majority vote. That is:

$$\begin{matrix}a ) GradEstimate ( x ) = \frac{1}{bq} {\sum }_{i ∈ {ℐ}_{k}}^{ } {\sum }_{j = 1}^{q} \frac{d [ {f}_{i} ( x + μ {u}_{i , j} ) - {f}_{i} ( x - μ {u}_{i , j} ) ] {u}_{i , j}}{2 μ} & ( 9 ) \\ b ) GradEstimate ( x ) = \frac{1}{bq} {\sum }_{i ∈ {ℐ}_{k}}^{ } {\sum }_{j = 1}^{q} sign ( \hat{∇} {f}_{i} ( x ; {u}_{i , j} ) ) , & ( 10 )\end{matrix}$$

where {u_{i,j}} and \hat{∇}ƒᵢ(x; u_{i,j}) have been defined in (3).

The ZO gradient estimator (9) has been used for bandit convex optimization. Compared to the form of forward difference (3), the central difference (9) requires b(q−1) times more function queries in gradient estimation. At the cost of more function queries, one may wonder if the convergence rate of ZO-signSGD can be further improved. This question is answered in Corollary 1 below.

Corollary 1: Suppose that the conditions in Theorem 1 hold, ZO-signSGD with gradient estimator (9) yields the same convergence rate of ZO-signSGD that uses the estimator (3). Proof: Recall that Proposition 1 is independent of specific forms of gradient estimators, and thus holds for (9). Although Proposition 2 relies on the second-order moments of each gradient estimator, the inventors prove that under A1 and A2, both (3) and (9) maintain the same statistical properties. As a result, Proposition 2 and Theorem 1 also hold for (9).

The gradient estimator (10) is next considered, whose sign is equivalent to the majority vote (i.e., the element-wise median) of signs of individual gradient estimates {\hat{∇}ƒᵢ(x; u_{i,j})}. It has been shown that signSGD with majority vote has a better convergence rate under additional assumptions of unimodal symmetric noise distribution of coordinate-wise gradient estimates. In Corollary 2, it is further shown that such a speed-up in convergence can also be achieved by ZO-signSGD with majority vote, which is referred to as “ZO-M-signSGD”.

$$\begin{matrix}Corollary 2 Suppose that the conditions in Theorem I & ( 11 ) \\ hold , and the distribution of gradient noise is unimodal & \\ and symmetric . Then , ZO \text{-} M \text{-} signSGD with & \\ {δ}_{k} = O ( \frac{1}{\sqrt{dT}} ) and μ = O ( \frac{1}{\sqrt{dT}} ) yields & \\ 𝔼 [ {‖ ∇ f ( {x}_{R} ) ‖}_{2} ] = O ( \sqrt{d} / \sqrt{T} + d / \sqrt{bq} ) . & \end{matrix}$$

It is noted that from Theorem 1 that under the same parameter setting of Corollary 2, ZO-signSGD, yields

$$O ( \frac{\sqrt{d}}{\sqrt{T }} + \frac{\sqrt{d}}{\sqrt{b }} + \frac{d}{\sqrt{bq }} )$$

convergence rate in the worst case. It is clear from (11) that the error correction term of order

$$\frac{\sqrt{d}}{\sqrt{b }}$$

is eliminated in ZO-M-signSGD. Such an improvement in convergence is achieved under the condition of unimodal symmetric gradient noise. It is noted that different from the stochastic gradient noise, the ZO gradient estimation noise could violate this assumption. For example, in a scalar case, if the gradient estimate g follows the distribution where g=1 with probability 0.9, g=−10 with probability 0.1, then E[g]<0 and sign(E[g])<0. However, E[sign(g)]>0. This implies that without the assumption of symmetry, the sign of gradient estimates with majority vote (E[sign(g)]) can be in the opposite direction of the sign of averaged gradients (sign(E[g])).

Experimental Results

Effectiveness is empirically shown of ZO-signSGD, and its convergence behavior is validated on both synthetic and real-world datasets such as MNIST and CIFAR-10. For the synthetic experiment, the problem of binary classification is studied in the least squared formulation. For the real-world application, we adversarial examples are designed from black-box neural networks. ZO-signSGD and its variants is compared with SGD, signSGD, ZO-SGD, and ZO-SCD.

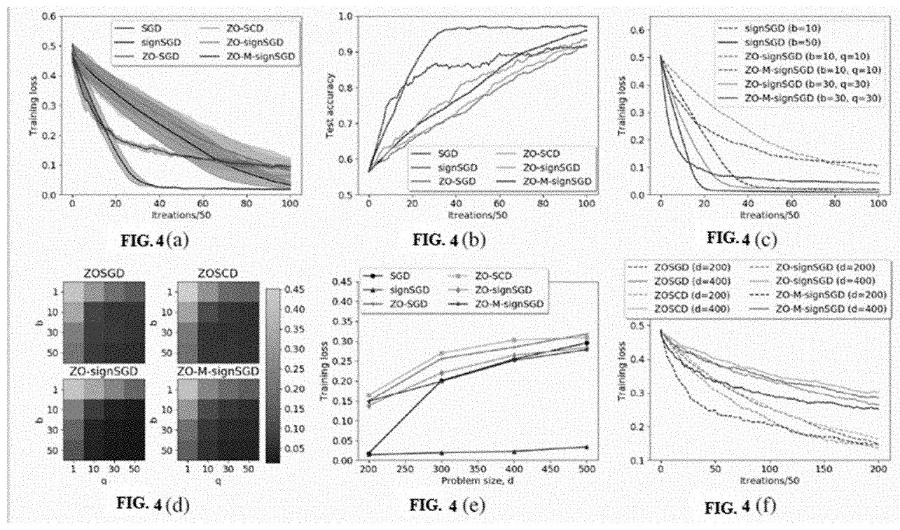

Results are shown in FIGS. 4(a)-(f) which depicts a performance comparison of ZO-signSGD, ZO-M-signSGD, ZO-SGD, ZO-SCD, signSGD and SGD under a synthetic dataset. The solid line represents the loss/accuracy averaged over 10 independent trials with random initialization, and the shaded region indicates the standard deviation of results over random trials. FIGS. 4(a)-(b) depict a training loss and test accuracy versus iterations. FIGS. 4(c)-(d) depict effects of mini-batch size q and number of random direction vectors q on the convergence of studied algorithms. Here FIG. 4(c) presents the training loss versus iterations, and FIG. 4(d) is the heat map of the final loss for different values of b and q. FIGS. 4(e)-(f) depict effects of problem size d. Here, FIG. 4(e) shows the final training loss versus d, and FIG. 4(f) presents the convergence trajectory when d∈{200, 400}.

That is, the least-squared problem of the form

$${min}_{x ∈ {ℝ}^{d}} \frac{1}{n} {\sum }_{i = 1}^{n} {( {y}_{i} - 1 / ( 1 + {e}^{- {a}_{i}^{T} x} ) )}^{2}$$

is considered. For generating the synthetic dataset, one randomly draws samples of {aᵢ} from N (0, I), and obtain the label yᵢ=1 if 1/(1+e^{-a}^{ᵢ}^{^{T}}^{x})>0.5 and 0 otherwise. The number of training samples {aᵢ, yᵢ} is set by n=2000 against 200 testing samples. It is found that the best constant learning rate for algorithms via a greedy search over η∈[0.001, 0.1], and the experiment chooses the smoothing parameter μ=10/√T d. Unless specified otherwise, let b=q=10, T=5000 and d=100. In FIGS. 4(a)-(f), as discussed above, the training loss, the test accuracy, as well as the effects of algorithmic parameters on the convergence of the studied algorithms are shown. It is observed from FIGS. 4(a)-4(b) that ZO-signSGD outperforms other ZO algorithms, and signSGD yields the best convergence performance once the first-order information is available. In FIGS. 4(c)-4(d), it is observed that the convergence performance of ZO algorithms is improved as b and q increase. In particular, ZO-signSGD and ZO-M-signSGD at b=q=30 approach to the best result provided by signSGD. In FIGS. 4(e)-4(f), the convergence of all algorithms degrades as the problem size d increases. However, ZO-signSGD and ZO-M-signSGD converge faster than ZO-SGD and ZO-SCD.

Adversarial robustness is studied by generating adversarial examples from a black-box image classifier trained by a deep neural network (DNN) model. Again, it is noted that that the task of a black-box adversarial attack falls within the category of ZO optimization as one can only access to the input-output relation of the DNN while crafting adversarial examples.

The DNN models trained on MNIST and CIFAR-10 are performed as the zeroth-order oracle. One image from each class of MNIST and CIFAR-10 is selected and separately implement black-box attacks using the same attacking loss function but with different ZO optimization algorithms (ZO-SGD, ZO-signSGD, and ZO-M-signSGD). The same parameters are also set for each method, i.e., μ=0.01, q=10, and δ=0.05 for MNIST and δ=0.0005 for CIFAR-10, to accommodate to the dimension factor d. All methods use the same natural image as the initial point for finding adversarial examples.

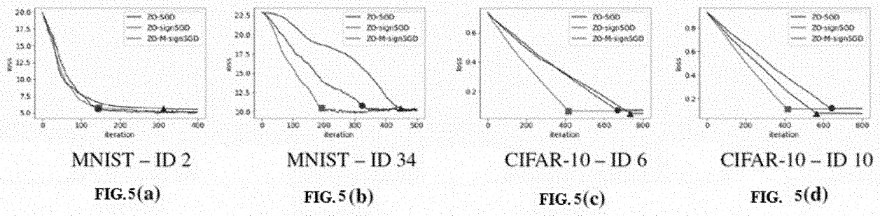

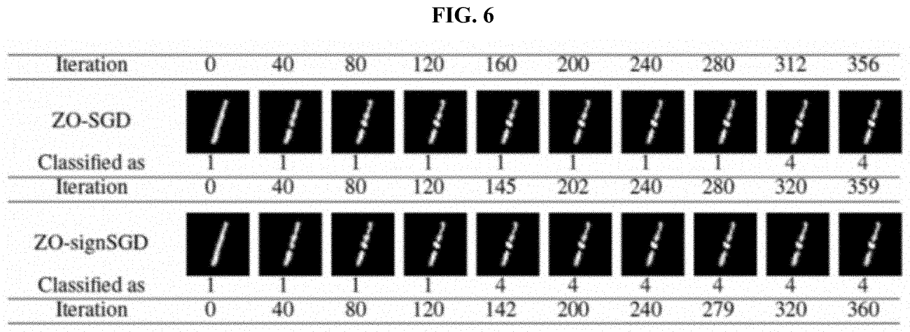

FIGS. 5(a)-4(d) shows the plots of black-box attacking loss versus iterations. It is found that ZO-signSGD usually takes significantly less iterations than other methods to find the first successful adversarial example with a similar attacking loss. For MNIST, the average iteration to find the first successful adversarial example is 184 for ZO-SGD, 103 for ZO-signSGD, and 151 for ZO-M-signSGD. Their corresponding average 12 distortion is 2.345 for ZO-SGD, 2.381 for ZO-signSGD, and 2.418 for ZO-M-signSGD. For CIFAR-10, the average iteration to find the first successful adversarial example is 302 for ZO-SGD, 250 for ZO-signSGD, and 389 for ZO-M-signSGD. Their corresponding average 12 distortion is 0.177 for ZO-SGD, 0.208 for ZO-signSGD, and 0.219 for ZO-M-signSGD. As a visual illustration, the adversarial examples of a hand-written digit “1” are compared of each attacking method at different iterations in FIG. 6, corresponding to FIG. 5(a). As is seen, ZO-signSGD and ZO-M-signSGD can reduce roughly 54% of iterations (around 600 less model queries) than ZO-SGD to find the first successful adversarial example with a similar l₂ distortion. Note that the first successful adversarial examples are visually similar to the original ones, but lead to different top-1 predictions.

Exemplary Aspects, Using a Cloud Computing Environment

Although this detailed description includes an exemplary embodiment of the present invention in a cloud computing environment, it is to be understood that implementation of the teachings recited herein are not limited to such a cloud computing environment. Rather, embodiments of the present invention are capable of being implemented in conjunction with any other type of computing environment now known or later developed.

Cloud computing is a model of service delivery for enabling convenient, on-demand network access to a shared pool of configurable computing resources (e.g. networks, network bandwidth, servers, processing, memory, storage, applications, virtual machines, and services) that can be rapidly provisioned and released with minimal management effort or interaction with a provider of the service. This cloud model may include at least five characteristics, at least three service models, and at least four deployment models.

Characteristics are as follows:

On-demand self-service: a cloud consumer can unilaterally provision computing capabilities, such as server time and network storage, as needed automatically without requiring human interaction with the service's provider.

Broad network access: capabilities are available over a network and accessed through standard mechanisms that promote use by heterogeneous thin or thick client platforms (e.g., mobile phones, laptops, and PDAs).

Resource pooling: the provider's computing resources are pooled to serve multiple consumers using a multi-tenant model, with different physical and virtual resources dynamically assigned and reassigned according to demand. There is a sense of location independence in that the consumer generally has no control or knowledge over the exact location of the provided resources but may be able to specify location at a higher level of abstraction (e.g., country, state, or datacenter).

Rapid elasticity: capabilities can be rapidly and elastically provisioned, in some cases automatically, to quickly scale out and rapidly released to quickly scale in. To the consumer, the capabilities available for provisioning often appear to be unlimited and can be purchased in any quantity at any time.

Measured service: cloud systems automatically control and optimize resource use by leveraging a metering capability at some level of abstraction appropriate to the type of service (e.g., storage, processing, bandwidth, and active user accounts). Resource usage can be monitored, controlled, and reported providing transparency for both the provider and consumer of the utilized service.

Service Models are as follows:

Software as a Service (SaaS): the capability provided to the consumer is to use the provider's applications running on a cloud infrastructure. The applications are accessible from various client circuits through a thin client interface such as a web browser (e.g., web-based e-mail). The consumer does not manage or control the underlying cloud infrastructure including network, servers, operating systems, storage, or even individual application capabilities, with the possible exception of limited user-specific application configuration settings.

Platform as a Service (PaaS): the capability provided to the consumer is to deploy onto the cloud infrastructure consumer-created or acquired applications created using programming languages and tools supported by the provider. The consumer does not manage or control the underlying cloud infrastructure including networks, servers, operating systems, or storage, but has control over the deployed applications and possibly application hosting environment configurations.

Infrastructure as a Service (IaaS): the capability provided to the consumer is to provision processing, storage, networks, and other fundamental computing resources where the consumer is able to deploy and run arbitrary software, which can include operating systems and applications. The consumer does not manage or control the underlying cloud infrastructure but has control over operating systems, storage, deployed applications, and possibly limited control of select networking components (e.g., host firewalls).

Deployment Models are as follows:

Private cloud: the cloud infrastructure is operated solely for an organization. It may be managed by the organization or a third party and may exist on-premises or off-premises.

Community cloud: the cloud infrastructure is shared by several organizations and supports a specific community that has shared concerns (e.g., mission, security requirements, policy, and compliance considerations). It may be managed by the organizations or a third party and may exist on-premises or off-premises.

Public cloud: the cloud infrastructure is made available to the general public or a large industry group and is owned by an organization selling cloud services.

Hybrid cloud: the cloud infrastructure is a composition of two or more clouds (private, community, or public) that remain unique entities but are bound together by standardized or proprietary technology that enables data and application portability (e.g., cloud bursting for load-balancing between clouds).

A cloud computing environment is service oriented with a focus on statelessness, low coupling, modularity, and semantic interoperability. At the heart of cloud computing is an infrastructure comprising a network of interconnected nodes.

Referring now to FIG. 7, a schematic of an example of a cloud computing node is shown. Cloud computing node 10 is only one example of a suitable node and is not intended to suggest any limitation as to the scope of use or functionality of embodiments of the invention described herein. Regardless, cloud computing node 10 is capable of being implemented and/or performing any of the functionality set forth herein.

Although cloud computing node 10 is depicted as a computer system/server 12, it is understood to be operational with numerous other general purpose or special purpose computing system environments or configurations. Examples of well-known computing systems, environments, and/or configurations that may be suitable for use with computer system/server 12 include, but are not limited to, personal computer systems, server computer systems, thin clients, thick clients, hand-held or laptop circuits, multiprocessor systems, microprocessor-based systems, set top boxes, programmable consumer electronics, network PCs, minicomputer systems, mainframe computer systems, and distributed cloud computing environments that include any of the above systems or circuits, and the like.

Computer system/server 12 may be described in the general context of computer system-executable instructions, such as program modules, being executed by a computer system. Generally, program modules may include routines, programs, objects, components, logic, data structures, and so on that perform particular tasks or implement particular abstract data types. Computer system/server 12 may be practiced in distributed cloud computing environments where tasks are performed by remote processing circuits that are linked through a communications network. In a distributed cloud computing environment, program modules may be located in both local and remote computer system storage media including memory storage circuits.

Referring now to FIG. 7, a computer system/server 12 is shown in the form of a general-purpose computing circuit. The components of computer system/server 12 may include, but are not limited to, one or more processors or processing units 16, a system memory 28, and a bus 18 that couples various system components including system memory 28 to processor 16.

Bus 18 represents one or more of any of several types of bus structures, including a memory bus or memory controller, a peripheral bus, an accelerated graphics port, and a processor or local bus using any of a variety of bus architectures. By way of example, and not limitation, such architectures include Industry Standard Architecture (ISA) bus, Micro Channel Architecture (MCA) bus, Enhanced ISA (EISA) bus, Video Electronics Standards Association (VESA) local bus, and Peripheral Component Interconnects (PCI) bus.

Computer system/server 12 typically includes a variety of computer system readable media. Such media may be any available media that is accessible by computer system/server 12, and it includes both volatile and non-volatile media, removable and non-removable media.

System memory 28 can include computer system readable media in the form of volatile memory, such as random access memory (RAM) 30 and/or cache memory 32. Computer system/server 12 may further include other removable/non-removable, volatile/non-volatile computer system storage media. By way of example only, storage system 34 can be provided for reading from and writing to a non-removable, non-volatile magnetic media (not shown and typically called a “hard drive”). Although not shown, a magnetic disk drive for reading from and writing to a removable, non-volatile magnetic disk (e.g., a “floppy disk”), and an optical disk drive for reading from or writing to a removable, non-volatile optical disk such as a CD-ROM, DVD-ROM or other optical media can be provided. In such instances, each can be connected to bus 18 by one or more data media interfaces. As will be further described below, memory 28 may include a computer program product storing one or program modules 42 comprising computer readable instructions configured to carry out one or more features of the present invention.

Program/utility 40, having a set (at least one) of program modules 42, may be stored in memory 28 by way of example, and not limitation, as well as an operating system, one or more application programs, other program modules, and program data. Each of the operating system, one or more application programs, other program modules, and program data or some combination thereof, may be adapted for implementation in a networking environment. In some embodiments, program modules 42 are adapted to generally carry out one or more functions and/or methodologies of the present invention.

Computer system/server 12 may also communicate with one or more external devices 14 such as a keyboard, a pointing circuit, other peripherals, such as display 24, etc., and one or more components that facilitate interaction with computer system/server 12. Such communication can occur via Input/Output (I/O) interface 22, and/or any circuits (e.g., network card, modem, etc.) that enable computer system/server 12 to communicate with one or more other computing circuits. For example, computer system/server 12 can communicate with one or more networks such as a local area network (LAN), a general wide area network (WAN), and/or a public network (e.g., the Internet) via network adapter 20. As depicted, network adapter 20 communicates with the other components of computer system/server 12 via bus 18. It should be understood that although not shown, other hardware and/or software components could be used in conjunction with computer system/server 12. Examples, include, but are not limited to: microcode, circuit drivers, redundant processing units, external disk drive arrays, RAID systems, tape drives, and data archival storage systems, etc.

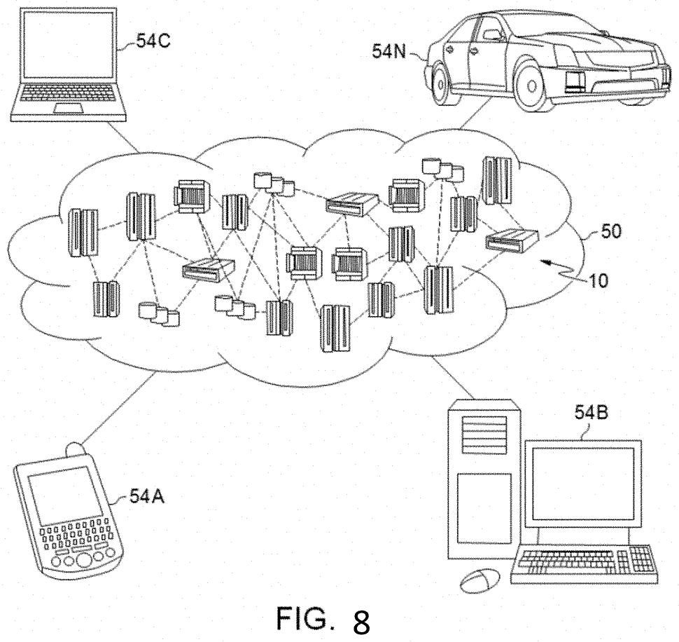

Referring now to FIG. 8, illustrative cloud computing environment 50 is depicted. As shown, cloud computing environment 50 comprises one or more cloud computing nodes 10 with which local computing circuits used by cloud consumers, such as, for example, personal digital assistant (PDA) or cellular telephone 54A, desktop computer 54B, laptop computer 54C, and/or automobile computer system 54N may communicate. Nodes 10 may communicate with one another. They may be grouped (not shown) physically or virtually, in one or more networks, such as Private, Community, Public, or Hybrid clouds as described hereinabove, or a combination thereof. This allows cloud computing environment 50 to offer infrastructure, platforms and/or software as services for which a cloud consumer does not need to maintain resources on a local computing circuit. It is understood that the types of computing circuits 54A-N shown in FIG. 8 are intended to be illustrative only and that computing nodes 10 and cloud computing environment 50 can communicate with any type of computerized circuit over any type of network and/or network addressable connection (e.g., using a web browser).

Referring now to FIG. 9, an exemplary set of functional abstraction layers provided by cloud computing environment 50 (FIG. 8) is shown. It should be understood in advance that the components, layers, and functions shown in FIG. 9 are intended to be illustrative only and embodiments of the invention are not limited thereto. As depicted, the following layers and corresponding functions are provided:

Hardware and software layer 60 includes hardware and software components. Examples of hardware components include: mainframes 61; RISC (Reduced Instruction Set Computer) architecture based servers 62; servers 63; blade servers 64; storage circuits 65; and networks and networking components 66. In some embodiments, software components include network application server software 67 and database software 68.

Virtualization layer 70 provides an abstraction layer from which the following examples of virtual entities may be provided: virtual servers 71; virtual storage 72; virtual networks 73, including virtual private networks; virtual applications and operating systems 74; and virtual clients 75.

In one example, management layer 80 may provide the functions described below. Resource provisioning 81 provides dynamic procurement of computing resources and other resources that are utilized to perform tasks within the cloud computing environment. Metering and Pricing 82 provide cost tracking as resources are utilized within the cloud computing environment, and billing or invoicing for consumption of these resources. In one example, these resources may comprise application software licenses. Security provides identity verification for cloud consumers and tasks, as well as protection for data and other resources. User portal 83 provides access to the cloud computing environment for consumers and system administrators. Service level management 84 provides cloud computing resource allocation and management such that required service levels are met. Service Level Agreement (SLA) planning and fulfillment 85 provide pre-arrangement for, and procurement of, cloud computing resources for which a future requirement is anticipated in accordance with an SLA.

Workloads layer 90 provides examples of functionality for which the cloud computing environment may be utilized. Examples of workloads and functions which may be provided from this layer include: mapping and navigation 91; software development and lifecycle management 92; virtual classroom education delivery 93; data analytics processing 94; transaction processing 95; and black box optimization method 100 in accordance with the present invention.

The present invention may be a system, a method, and/or a computer program product at any possible technical detail level of integration. The computer program product may include a computer readable storage medium (or media) having computer readable program instructions thereon for causing a processor to carry out aspects of the present invention.

The computer readable storage medium can be a tangible device that can retain and store instructions for use by an instruction execution device. The computer readable storage medium may be, for example, but is not limited to, an electronic storage device, a magnetic storage device, an optical storage device, an electromagnetic storage device, a semiconductor storage device, or any suitable combination of the foregoing. A non-exhaustive list of more specific examples of the computer readable storage medium includes the following: a portable computer diskette, a hard disk, a random access memory (RAM), a read-only memory (ROM), an erasable programmable read-only memory (EPROM or Flash memory), a static random access memory (SRAM), a portable compact disc read-only memory (CD-ROM), a digital versatile disk (DVD), a memory stick, a floppy disk, a mechanically encoded device such as punch-cards or raised structures in a groove having instructions recorded thereon, and any suitable combination of the foregoing. A computer readable storage medium, as used herein, is not to be construed as being transitory signals per se, such as radio waves or other freely propagating electromagnetic waves, electromagnetic waves propagating through a waveguide or other transmission media (e.g., light pulses passing through a fiber-optic cable), or electrical signals transmitted through a wire.

Computer readable program instructions described herein can be downloaded to respective computing/processing devices from a computer readable storage medium or to an external computer or external storage device via a network, for example, the Internet, a local area network, a wide area network and/or a wireless network. The network may comprise copper transmission cables, optical transmission fibers, wireless transmission, routers, firewalls, switches, gateway computers and/or edge servers. A network adapter card or network interface in each computing/processing device receives computer readable program instructions from the network and forwards the computer readable program instructions for storage in a computer readable storage medium within the respective computing/processing device.

Computer readable program instructions for carrying out operations of the present invention may be assembler instructions, instruction-set-architecture (ISA) instructions, machine instructions, machine dependent instructions, microcode, firmware instructions, state-setting data, configuration data for integrated circuitry, or either source code or object code written in any combination of one or more programming languages, including an object oriented programming language such as Smalltalk, C++, or the like, and procedural programming languages, such as the “C” programming language or similar programming languages. The computer readable program instructions may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider). In some embodiments, electronic circuitry including, for example, programmable logic circuitry, field-programmable gate arrays (FPGA), or programmable logic arrays (PLA) may execute the computer readable program instructions by utilizing state information of the computer readable program instructions to personalize the electronic circuitry, in order to perform aspects of the present invention.

Aspects of the present invention are described herein with reference to flowchart illustrations and/or block diagrams of methods, apparatus (systems), and computer program products according to embodiments of the invention. It will be understood that each block of the flowchart illustrations and/or block diagrams, and combinations of blocks in the flowchart illustrations and/or block diagrams, can be implemented by computer readable program instructions.

These computer readable program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks. These computer readable program instructions may also be stored in a computer readable storage medium that can direct a computer, a programmable data processing apparatus, and/or other devices to function in a particular manner, such that the computer readable storage medium having instructions stored therein comprises an article of manufacture including instructions which implement aspects of the function/act specified in the flowchart and/or block diagram block or blocks.

The computer readable program instructions may also be loaded onto a computer, other programmable data processing apparatus, or other device to cause a series of operational steps to be performed on the computer, other programmable apparatus or other device to produce a computer implemented process, such that the instructions which execute on the computer, other programmable apparatus, or other device implement the functions/acts specified in the flowchart and/or block diagram block or blocks.

The flowchart and block diagrams in the Figures illustrate the architecture, functionality, and operation of possible implementations of systems, methods, and computer program products according to various embodiments of the present invention. In this regard, each block in the flowchart or block diagrams may represent a module, segment, or portion of instructions, which comprises one or more executable instructions for implementing the specified logical function(s). In some alternative implementations, the functions noted in the blocks may occur out of the order noted in the Figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts or carry out combinations of special purpose hardware and computer instructions.

The descriptions of the various embodiments of the present invention have been presented for purposes of illustration, but are not intended to be exhaustive or limited to the embodiments disclosed. Many modifications and variations will be apparent to those of ordinary skill in the art without departing from the scope and spirit of the described embodiments. The terminology used herein was chosen to best explain the principles of the embodiments, the practical application or technical improvement over technologies found in the marketplace, or to enable others of ordinary skill in the art to understand the embodiments disclosed herein.

Further, Applicant's intent is to encompass the equivalents of all claim elements, and no amendment to any claim of the present application should be construed as a disclaimer of any interest in or right to an equivalent of any element or feature of the amended claim.

What is claimed is:

1. A computer-implemented black box optimization method, the method comprising:
implementing an average gradient estimator using a forward difference of function values at multiple random directions;
performing variance reduction via gradient blending with an output of the average gradient estimator using a control variate; and
performing binary quantization of a result of the variance reduction.

2. The method of claim 1, further comprising performing a gradient descent optimization with a result from the binary quantization to optimize an output of a black box.

3. The method of claim 1, wherein the average gradient estimator includes using different types of gradient estimators using a central difference of the function values.

4. The method of claim 1, wherein the average gradient estimator includes using signs of estimates with a majority vote.

5. The method of claim 1, further comprising measuring a gap between the output of the average gradient estimator and a true gradient via a smoothing function.

6. The method of claim 1, further comprising evaluating an error propagation from a sign of the output of the average gradient estimator to a true gradient.

7. The method of claim 1, embodied in a cloud-computing environment.

8. A computer program product for black box optimization, the computer program product comprising a computer-readable storage medium having program instructions embodied therewith, the program instructions executable by a computer to cause the computer to perform:
implementing an average gradient estimator using a forward difference of function values at multiple random directions;
performing variance reduction via gradient blending with an output of the average gradient estimator using a control variate; and
performing binary quantization of a result of the variance reduction.

9. The computer program product of claim 8, further comprising performing a gradient descent optimization with a result from the binary quantization to optimize an output of a black box.

10. The computer program product of claim 8, wherein the average gradient estimator includes using different types of gradient estimators using a central difference of the function values.

11. The computer program product of claim 8, wherein the average gradient estimator includes using signs of estimates with a majority vote.

12. The computer program product of claim 8, further comprising measuring a gap between the output of the average gradient estimator and a true gradient via a smoothing function.

13. The computer program product of claim 8, further comprising evaluating an error propagation from a sign of the output of the average gradient estimator to a true gradient.

14. A black box optimization system, the system comprising:
a processor, and
a memory, the memory storing instructions to cause the processor to perform:
implementing an average gradient estimator using a forward difference of function values at multiple random directions;
performing variance reduction via gradient blending with an output of the average gradient estimator using a control variate; and
performing binary quantization of a result of the variance reduction.

15. The system of claim 14, further comprising performing a gradient descent optimization with a result from the binary quantization to optimize an output of a black box.

16. The system of claim 14, wherein the average gradient estimator includes using different types of gradient estimators using a central difference of the function values.

17. The system of claim 14, wherein the average gradient estimator includes using signs of estimates with a majority vote.

18. The system of claim 14, further comprising measuring a gap between the output of the average gradient estimator and a true gradient via a smoothing function.

19. The system of claim 14, further comprising evaluating an error propagation from a sign of the output of the average gradient estimator to a true gradient.

20. The system of claim 14, embodied in a cloud-computing environment.
